(19) United States
(12) Patent Application Publication
(10) Pub. No.: US 2005/0125550 A1
(43) Pub. Date: Jun. 9, 2005

(54) Location information via DHCP

(76) Inventor: Sundeep M. Bajikar, Mountain View, CA (US)

Correspondence Address: BUCKLEY, MASCHOFF, TALWALKAR LLC, 5 ELM STREET, NEW CANAAN, CT, 06840, US

(21) Appl. No.: 10/731,649

(22) Filed: Dec. 9, 2003

(51) Int. Cl. G06F 15/16

(52) U.S. Cl. 709/230

(57) ABSTRACT

According to some embodiments, location information may be included in a dynamic host configuration protocol (DHCP) message.

### BACKGROUND

Devices connected to wired or wireless networks often communicate with each other to exchange, collect, or share various forms of information. In many situations the method of transmitting the information or the information itself may be dependent upon the physical location of the various network devices. Because many network devices are mobile, wireless, or otherwise transitory in nature however, the physical location of these devices is often not known or not shared with other network devices. This lack of location awareness among network devices may reduce the effectiveness of network communications and prevent the utilization of location-dependent features and functions.

### BRIEF DESCRIPTION OF THE DRAWINGS

FIG. 1 is a block diagram of a system.

FIG. 2 is a block diagram of a dynamic host configuration protocol (DHCP) message.

FIG. 3 is a block diagram of a DHCP message.

FIG. 4 is a flow diagram of a method according to some embodiments.

FIG. 5 is a block diagram of a DHCP message according to some embodiments.

FIG. 6 is a flow diagram of a method according to some embodiments.

FIG. 7 is a flow diagram of a method according to some embodiments.

FIG. 8 is a block diagram of a system according to some embodiments.

FIG. 9 is a block diagram of a table according to some embodiments.

FIG. 10 is a block diagram of a system according to some embodiments.

### DETAILED DESCRIPTION

Some embodiments described herein are associated with a “Dynamic Host Configuration Protocol” or “DHCP”. As used herein, the terms “Dynamic Host Configuration Protocol” and “DHCP” may be used interchangeably and generally refer to a framework, protocol, and/or method for automating, managing, and/or conducting the configuration of network devices. An example of such a protocol is that defined by the Internet Engineering Task Force (IETF) Dynamic Host Configuration Protocol for IPv6 (DHCPv6), RFC 3315, Droms et al., July, 2003. Other versions of DHCP and other configuration protocols may be used in accordance with some embodiments.

By way of example, a network client and a network server operating on a network may exchange DHCP messages to assign an Internet Protocol (IP) address to the network client upon connection of the network client to the network. As used herein, the term “DHCP message” generally refers to any string, code, command, signal, packet, datagram, information, and/or other communication associated with the configuration of a network device. Examples of DHCP messages and message formats may be found in the specifications for DHCPv6 as cited above, and are also briefly described herein. Formats other than those referenced and/or described herein may also be used without deviating from the scope and purpose of the presented embodiments.

Some embodiments are associated with “locations”, “physical locations”, or “location information”. As used herein, the phrases “location” or “physical location” may be used interchangeably and may refer to any site, spot, point, place, and/or locale where an object or other device resides, occupies, exists, or can otherwise be associated with. As used herein, the term “location information” may refer to any data, string, coordinate, reference, identifier, and/or other information related to the location of a particular object, device, and/or grouping or other combination of objects and/or devices. Examples of location information include, but are not limited to, planar, cylindrical, polar, geodetic, and/or other coordinates, location descriptions or other identifiers, and/or any combination thereof.

In addition, some embodiments are associated with a “network device”. As used herein, the phrase “network device” may refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a communication device (e.g., a modem, a wireless phone, etc.). Network devices may comprise one or more network components. As used herein, the term “network component” may refer to a network device, or a component, piece, portion, or combination of network devices. Examples of network components may include a Static Random Access Memory (SRAM) device or module, a network processor, and a network communication path, connection, port, or cable.

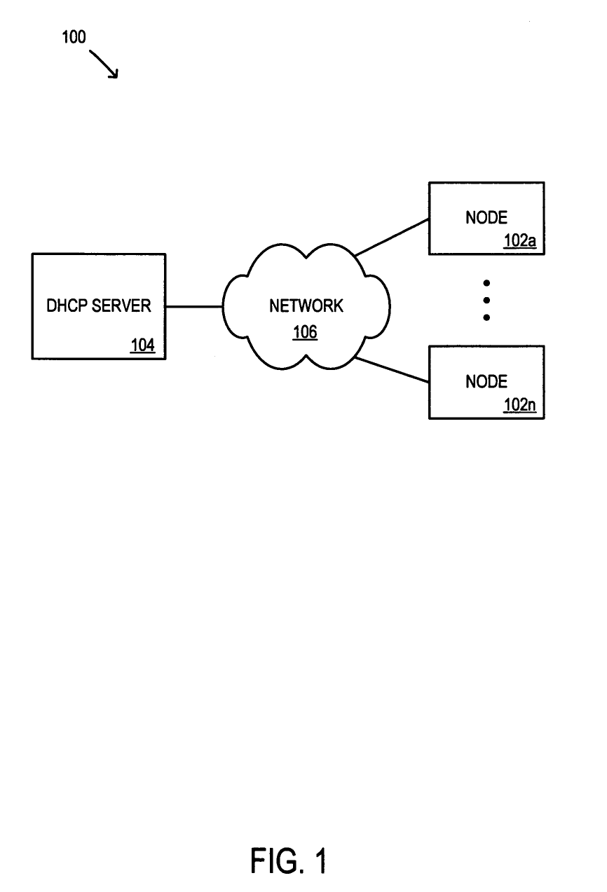

Referring first to FIG. 1, a block diagram of a system 100 for facilitating electronic communication is depicted for use in explanation, but not limitation, of described embodiments. Upon reading this disclosure, those skilled in the art will appreciate that different types, layouts, quantities, and configurations of systems may be used.

System 100 may comprise, for example, one or more network nodes 102a-102n connected to a DHCP server 104 via a network 106. The nodes 102a-102n may be or include any type or configuration of network devices including, for example, client computers such as corporate workstations. In some embodiments, the nodes 102a-102n may be or include one or more components of a network device. For example, a node 102 may be a network interface card (NIC) connected to a corporate workstation or other client computer. According to some embodiments, a node 102 may be or include a network cable, port, and/or other type of network connection or path. One or more network nodes 102a-102n may, according to some embodiments, be directly connected and/or otherwise in direct communication with each other (i.e., without using the network 106, for example).

The DHCP server 104 may be or include a network server or other network device capable of managing, sending, and/or receiving DHCP messages. In some embodiments, the DHCP server 104 may be a central server such as a corporate or internet service provider (ISP) server operating a DHCP system to manage and distribute IP addresses to network client devices such as network nodes 102a-102n. The DHCP server 104 may be a single server or other computing device or may be or include multiple and/or various network devices and components. In some embodiments, the DHCP server 104 may be or include a node 102. The system 100 may, for example, function without a separate, distinct, and/or dedicated DHCP server 104 (e.g., one or more of the nodes 102a-102n may manage and/or operate the system 100).

The network 106 may be any known or available type of wired or wireless network, and may also be or include a combination of networks of similar or varying types. The network 106 may be or include, for example, a Local Area Network (LAN), a Metropolitan Area Network (MAN), a Wide Area Network (WAN), a proprietary network, a wireless network, and/or an Internet Protocol (IP) network (e.g., an intranet or the Internet). According to some embodiments, the DHCP server 104 and one or more network nodes 102a-102n may exchange information over network 106 in accordance with the Fast Ethernet LAN transmission standard 802.3-2002® published by the Institute of Electrical and Electronics Engineers (IEEE).

By way of example, a node 102 may connect to the network 106 and transmit a DHCP message (such as a DHCP “SOLICIT” message) in an attempt to search for network servers capable of providing network configuration information. The DCHP server 104 may receive the message from the node 102 and send a reply DHCP message (e.g., an “ADVERTISE” or “REPLY” message type). The reply DHCP message may contain, for example, configuration and other information such as an available IP address that the node 102 may use to operate on the network 106. The DHCP server 104 and the node 102 may exchange other DCHP messages and/or message types relating to various procedures, protocols, and other necessary or desirable communications.

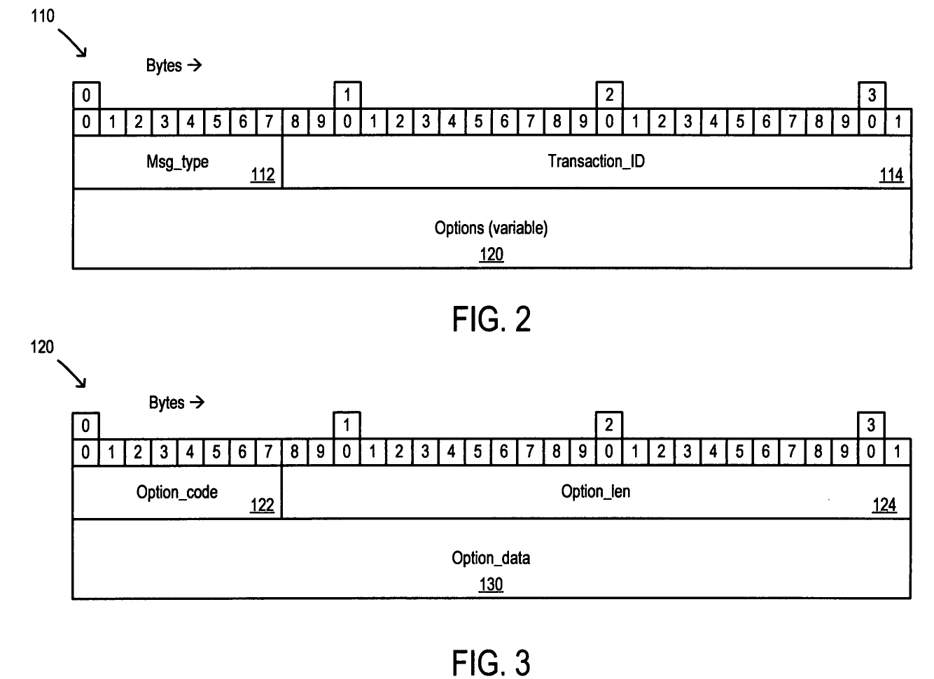

FIG. 2 shows an exemplary format of a DHCP message 110 that may be transmitted, for example, through the system 100. The message 110 is shown in network byte order, displaying information and/or variable types in their respective positioning and size within the message 110 in accordance with the specifications for DHCPv6 as cited herein. The message 110 may contain, for example, a message type field (Msg_type) 112, a transaction identification field (Transaction_ID) 114, and a variable-length options field (Options) 120. The message type field 112 may, for example, represent the purpose, content, and/or context of the message 110. In accordance with DHCPv6 for example, the message type field 112 may include a numerical identifier representing one of the various possible message types such as “ADVERTISE” or “REPLY” (represented by integers two and seven respectively). The transaction identification field 114 may contain information for keeping track of DHCP messages sent between various network devices. The transaction identification field 114 may be used, for example, to match related messages such as replies and responses, and/or to prevent messages from being sent or received at inappropriate and/or incorrect network locations.

The variable-length option field 120 may contain information associated with various option types and option parameters. Options may be or include information relating to and/or associated with various configuration, identification, and other communication related data. In the DHCP message described above where the DHCP server 104 sends the reply to the node 102 for example, the option field 120 may contain the IP address information intended for use by the node 102.

In FIG. 3 an exemplary format of a DHCP message option field 120 is shown. The option field 120 may contain, for example, an option code field (Option_code) 122, an option length field (Option_len) 124, and an option data field (Option_data) 130. The option code field 122 may indicate the type of option and/or the specific option represented in or by the option field 120. The option length field 124 may provide information indicative of the amount of information present and/or associated with a particular option. The option length field 124 may, for example, provide a value representing the amount of data present in the option data field 130. By way of example, the option length field 124 may indicate the number of octets or bytes of data within the option data field 130. The option data field 130 may contain information defining, modifying, representing, and/or establishing a particular option. The option data field 130 in a DHCP server's reply message as described above may contain, for example, the IP address to be assigned to a recipient node 102.

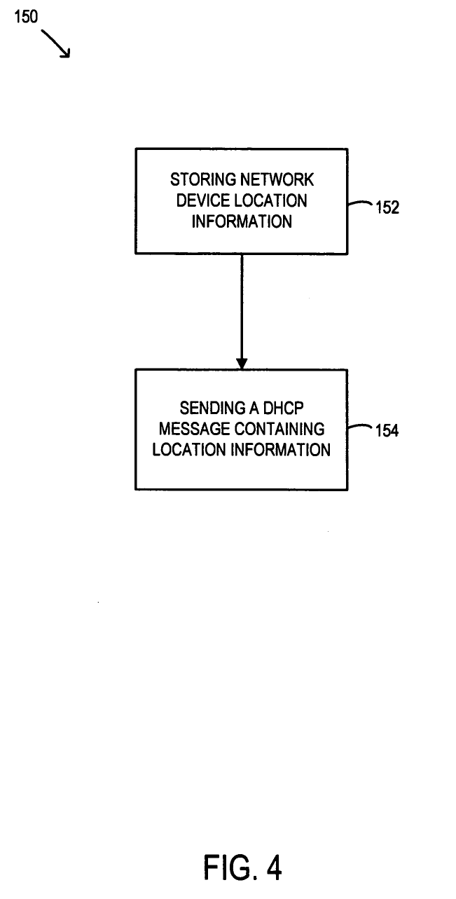

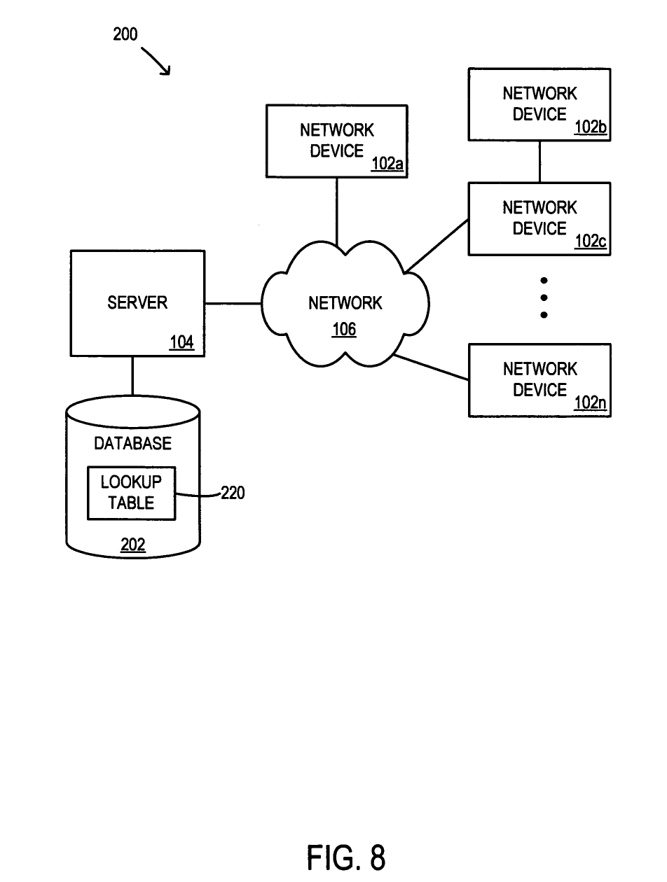

Turning now to FIG. 4, a flow diagram of a method 150 in accordance with some embodiments is shown. The method of FIG. 4 may be associated with and/or performed by, for example, the system 200 (or one or more of the system components) described in conjunction with FIG. 8 herein. The flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

In some embodiments (as shown in FIG. 4), the method 150 may begin by storing location information associated with one or more network devices and/or components, at 152. For example, a server or other network device may store, maintain, or otherwise have access to location information associated with various network devices. In some embodiments the location information may be or include geodetic coordinates. By way of example, a server may store latitude and longitude coordinate data representing the location of various network devices such as workstations, printers, and/or network access points (e.g., wall jacks, wireless receivers, etc.). In some embodiments the server may also store location information associated with the server itself and/or relating to one or more of the server's network components. Other network devices such as computer workstations, for example, may also store all or part of the necessary and/or desired location information. In some embodiments, a portable network device with a global positioning system (GPS) component may determine and/or store the current and/or past coordinate information associated with the portable device.

At 154, a DHCP message that contains location information may be sent from one network device to another. In some embodiments, the location information may be included as an option within a standard DHCP message type. The DHCP message may also, for example, be a special DHCP message created specifically to facilitate the exchange of location information. By way of example, a server having access to network access point location information may respond to a DHCP message sent over a network by a computer workstation. Assuming that the computer workstation is connected to a network access point having accessible location information, the server may, for example, send a DHCP message including the location information to the workstation. According to some embodiments, the server may send the location information associated with the server to the workstation in a DHCP message. Also in some embodiments, a network device such as a portable computer with a GPS component may connect to a wireless network and send a server (or other network device) a DHCP message containing the GPS and/or other coordinates associated with the portable device. In some embodiments, the network device that receives the DHCP message with location information may request such a message from the sending device.

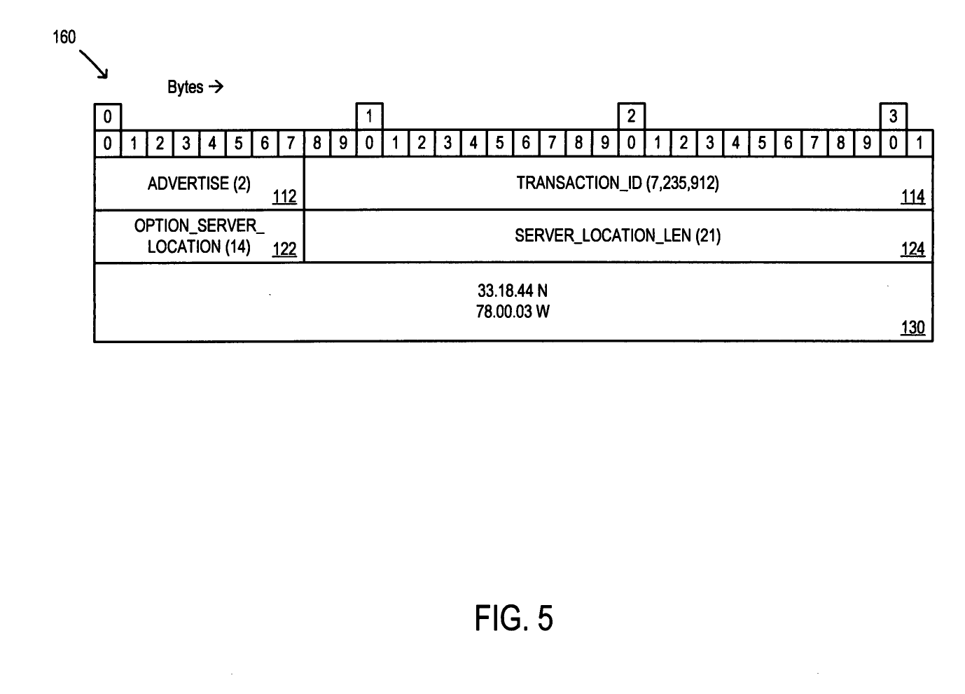

FIG. 5 shows an exemplary format of a DHCP message 160 that may be used, for example, by various network devices conducting method 150. The message 160 is shown in network byte order, displaying information and/or variable types in their respective positioning and size within the message 160. Specific exemplary values for certain variables are shown in parentheses adjacent to the associated variable name and/or other variable value or identifier. In some embodiments (and as shown in FIG. 5), the DHCP message 160 may be in a format similar to and/or in accordance with the specifications for DHCPv6. The DHCP message fields 112, 114, 122, 124, 130 may, according to some embodiments, be similar in composition and/or functionality to those described in conjunction with FIG. 2 and/or FIG. 3 herein.

By way of example, a computer workstation may send a DHCP “SOLICIT” message over a network to identify and/or locate DHCP-enabled servers. In some embodiments, the “SOLICIT” message may contain and/or be indicative of a request for location information. Also in some embodiments, the request for location information may specify and/or otherwise indicate a particular network device (or set or group of network devices) for which the location information is requested. The message may be received by a DHCP server and the DHCP server may lookup, access, and/or otherwise determine the appropriate location information associated with the computer workstation. The DHCP server may create and send a DHCP message containing the location information to the computer workstation. The message may, according to some embodiments, have a format as shown in FIG. 5. For example, the message type field 112 may contain the value “ADVERTISE” (or the corresponding integer identifier, two), indicating that the message is a response to a “SOLICIT” message. The transaction identification field 114 may, as described in conjunction with FIG. 2, contain an identifier (e.g., a numerical identifier such as “7,235,912”) indicating that the current message 160 is a response to the particular “SOLICIT” message having the same or associated transaction identifier. The option code field 122 may contain the name of the option being utilized by the current message 160.

For location information exchange purposes in accordance with some embodiments, the option code field 122 may contain, for example, the identifier “OPTION_SERVER_LOCATION” (or a possible corresponding integer identifier such as fourteen). The option length field 124 may, for example, represent the number of octets that the location information comprises. As shown in FIG. 5, the location information populated in the option data field 130 is described by the option length field 124 as being twenty-one octets in length. The option data field 130, according to some embodiments, contains the location information associated with the network device (in this case, the latitude and longitude coordinates of the computer workstation and/or the network access point through which the computer workstation is connected).

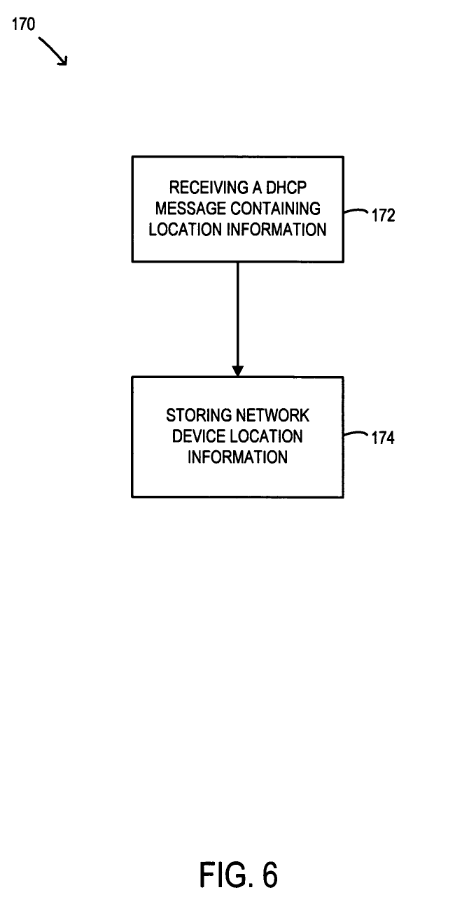

Turning now to FIG. 6, a flow diagram of a method 170 in accordance with some embodiments is shown. The method of FIG. 6 may be associated with and/or performed by, for example, the system 200 (or one or more of the system components) described in conjunction with FIG. 8 herein. The method 170 may begin, for example, by receiving a DHCP message containing location information, at 172. The DCHP message received may, according to some embodiments, be a DCHP message similar to those described in conjunction with method 150 and/or FIG. 5 herein.

By way of example, a DHCP server may receive a DHCP message from a network device. The network device may, in some embodiments, be location aware, and may provide the device's location information to the server via the DHCP message. As an example, a portable device with GPS capability may communicate with a DHCP server over a network. The portable device may continuously or intermittently transmit location information (e.g., GPS coordinates) to the DHCP server via DCHP messages. The DHCP server may receive the location information-laden DHCP message at 172.

At 174, the location information may be stored and/or otherwise recorded. Continuing the example from above, the DHCP server may store the location information associated with the portable device. The stored location information may be useful, for example, for tracking the portable device, enhancing communications and/or communications performance (e.g., directing communications through devices most proximate to the portable device's current location), and/or for various other processing or communications purposes. The information may be stored, as described elsewhere herein, in various locations accessible to the DHCP server and/or other network devices or components.

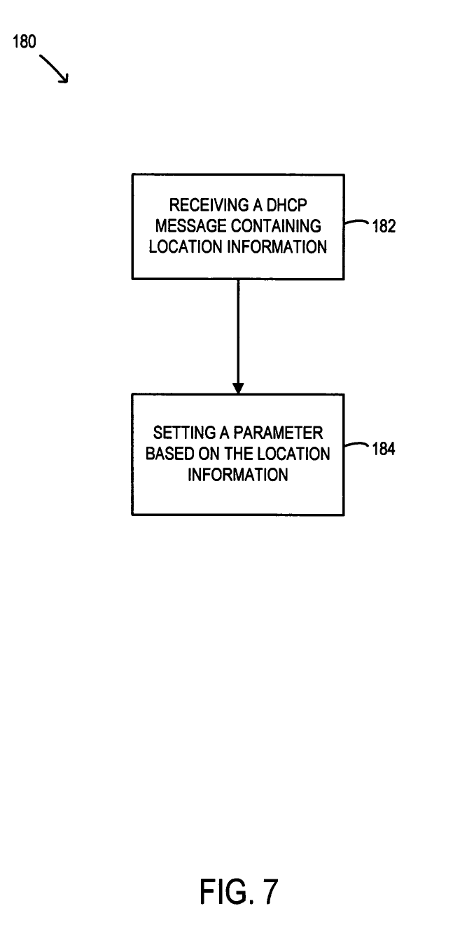

Referring now to FIG. 7, a flow diagram of a method 180 in accordance with some embodiments is shown. The method of FIG. 7 may be associated with and/or performed by, for example, the system 200 (or one or more of the system components) described in conjunction with FIG. 8 herein. The method 180 may begin, for example, in a similar manner to that described in conjunction with method 170 above. For example, a network device may receive location information via a DHCP message at 182. At 184, the network device may cause a parameter and/or other setting to be adjusted or determined based on the received location information. In some embodiments, the parameter or other value may be automatically updated and/or configured based upon the location information. For example, a network device may utilize location information associated with its current position to adjust clock and/or other system settings to be in accordance with parameters appropriate for the given location (e.g., updating a system clock to reflect the current time zone, adjusting modem settings to conform to local dial-out and/or other procedures, etc.). In some embodiments, the location information may be utilized by making the information available to other network devices. For example, a DHCP server receiving location information from a first portable or other device may make the information available to other devices operating on the network. One or more of the other devices may then utilize the location information of the first portable device to their advantage in various ways known to those skilled in the art. In some embodiments, the location information associated with various network devices may be used to determine, approximate, verify, and/or otherwise process or manipulate the location information associated with one or more other network devices.

Turning now to FIG. 8, a block diagram of a system 200 in accordance with some embodiments is shown. The system 200 may include, for example, one or more network devices 102a-102n, a server 104, a network 106, a database 202, and a lookup table 220. In some embodiments, the network devices 102a-102n, server 104, and network 106 may be similar in composition and/or functionality to the devices described in conjunction with FIG. 1 herein. In some embodiments the system 150 may have fewer or more components than those shown. Various methods including methods described herein 150, 170, 180 may be practiced, conducted, and/or facilitated by the system 200 and/or by any one (or combination) of the system components.

The database 202 may be or include any known or available type of data storage medium including, but not limited to, a hard disk drive, physical memory, virtual memory, Random-Access Memory (RAM), a Digital Video Disk (DVD), and/or a Compact Disc (CD). The database 202 may store any information associated with the server 104, the network 106, and/or one or more network devices 102a-102n, including location information associated with network devices 102a-102n. In some embodiments the database 202 may reside within, attached, and/or adjacent to the server 104. The database 202 may also be or include multiple databases, be a part or component of a separate network device 102a-102n, and/or may itself be a network device 102a-102n. In some embodiments, fewer or more databases 202 may be employed in system 200.

The lookup table 220 may be or include any type or configuration of data storage medium and/or device including, but not limited to, a memory module, a database table, a spreadsheet, and/or any other type or form of data file or repository. In some embodiments the lookup table 220 may reside within the server 104 or other network device 102a-102n. The lookup table 220 may also reside separately from and/or be independent from database 202.

In some embodiments, the server 104 may be a corporate enterprise server that performs various tasks related to network administration. The network 106 may be an intranet or other IP-based network that connects various resources within a corporation. The network devices 102a-102n may include, for example, multiple corporate workstations, printers, facsimile machines, and other network or Web servers located in, connected to, or otherwise associated with the corporate network 106. As shown in FIG. 8, some network devices 102b may be connected to the network 106 via other network devices 102c.

By way of example, when a particular network device 102b such as a laptop computer attempts to connect to the network 106, the network device 102b may send a DHCP message through the network to search for available DHCP-enabled servers. This may occur, for example, when a corporate employee attempts to connect their laptop and logon to a network in a branch office that the employee does not usually work from. The server 104 may receive the DHCP message and may reply to the network device 102b with a DCHP message containing and/or indicating an IP address that the network device 102b may use to operate on the corporate network 106.

Continuing the example, assuming that the network device 102b (the laptop) is operating from a physical location that is different from where it usual operates, it is most likely not location aware. In other words, the laptop 102b does not contain or have access to information relating to the physical position of the laptop in relation to any fixed or known point of reference. In some embodiments however, the laptop 102b may be connected through a network cable or other wired connection device to the network 106. For example, the laptop 102b may be connected via a Category 5, 5e, or 6 network cable to a wall receptacle 102c in an office or cubicle at the corporate branch office. The wall receptacle or jack 102c may be labeled, for example, “3N22a”, an identifier representing the wall jack 102c as being located on the north side of the third floor in room (or cubicle) number twenty-two, jack ‘a’.

In some embodiments, the server 104 may have access to physical location information associated with the various network connection points (such as wall jack 102c) located throughout the corporate branch office. By way of example, the server 104 may store or otherwise have access to location information associated with the wall jack 102c identified as “3N22a”, described above. In some embodiments, the location information for the wall jack 102c may include the latitude and longitude coordinates for that particular wall jack 102c. For example, the server 104 may be in connection with a database 202 that contains a lookup table 220 (as shown in FIG. 4). The lookup table 220 may contain a listing of corporate branch office network connection points (such as wall jack 102c) and the respective coordinates for each connection point.

According to some embodiments, the server 104 may lookup the location information associated with the wall jack 102c. This may be performed, for example, when the laptop 102b connects to the jack 102c and solicits the network with a DHCP message. In some embodiments, the server 104 may detect the connection of the laptop 102b to the network 106. According to some embodiments, the server 104 may access, lookup, and/or otherwise determine the available location information when the server 104 receives a DHCP message from the laptop 102b. The server 104 may then send the location information to the laptop 102b, making the laptop 102b location aware. The server 104 may also, according to some embodiments, make the laptop 102b location aware in response to the server 104 having detected the connection of the laptop 102b to the network 106. By way of example, the server 104 may respond to the laptop 102b with a DHCP message that includes the location information associated with wall jack 102c. The location information may be included in the DHCP message, for example, as and/or within a DHCP option. In some embodiments the laptop 102b may use the location information to update and/or otherwise configure various settings and/or parameters of the laptop 120b.

For example, the laptop 102b may connect to a wall jack 102c in a branch office as described above. The laptop 102b may solicit the network 106 by sending a DHCP message (through the wall jack 102c to network 106, for example). The server 104 may receive the DHCP message, lookup the location information associated with the wall jack 102c that the laptop 102b is communicating from, and send the location information to the laptop 102b as an option in a DHCP reply message. The laptop 102b may then, for example, automatically update the clock and/or regional settings of the laptop 102b to reflect the appropriate time zone (possibly including daylight savings time, etc.) determined by the received location information.

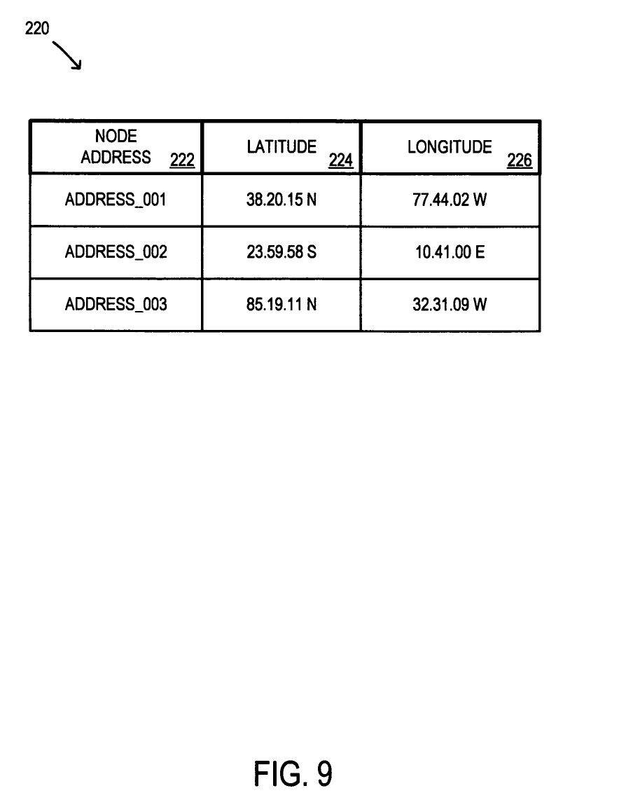

Referring now to FIG. 9, a block diagram of an exemplary database table 220 in accordance with some embodiments is shown. The exemplary database table 220 includes columns for node address 222, latitude 224, and longitude 226. As shown in FIG. 9, latitude and longitude coordinates are represented in decimal format for each node address 222. The node addresses 222 are shown as text values (“ADDRESS_{—}001, etc.) but may be stored in any acceptable and/or useful format known to those skilled in the art. For example, “ADDRESS_{—}001” may represent and/or otherwise be stored as “3N22a” (as used above to identify wall jack 102c). In accordance with embodiments described herein, other metrics associated with a network device (besides and/or in addition to the node address 222) may be similarly stored with respective location coordinates in the same or different tables or databases.

Multiple tables and/or databases may be used to store the information shown in FIG. 9, and fewer or more database columns and rows may be used in accordance with some embodiments. In some embodiments, a plurality of columns representing various coordinates and/or other location information for each network device 102a-102n may be used. The data shown in FIG. 9 is presented for exemplary purposes only and those skilled in the art will recognize that various types and/or configurations of data may be stored in such a table 220 without deviating from the scope of the claimed embodiments.

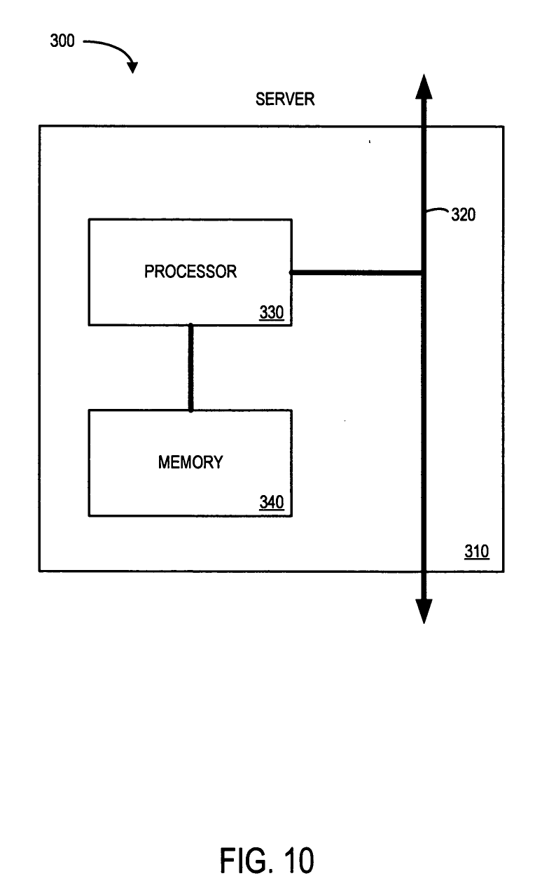

FIG. 10 is a block diagram of a system 300 according to some embodiments. The system 300 may include, for example, a server 310, a communications path 320, a processor 330, and memory 340. The server 310 may be any type of server including, for example, a DHCP server that assists in the automatic configuration of network-connected devices. The server 310 may have a communications path 320 for sending and/or receiving various communications. In some embodiments, the communications path 320 may be for sending and/or receiving DHCP messages in accordance with the methods 150, 170, 180 described herein. The communication path 320 may be any type and/or combination of wired, wireless, intermittent and/or continuous communication paths, connections, wires, devices, and/or ports known and/or available. The processor 330 may be any type of processor including, but not limited to, an Intel® IXP 2800 network processor or an Intel® XEON™ Processor coupled with an Intel® E7501 chipset. The memory 340 may be any type and/or configuration of data storage device known, available, and/or described herein. In some embodiments, the memory 340 may be used to store location information associated with various network devices. Also according to some embodiments, the processor 330 may utilize the location information stored in the memory 340 to create DHCP messages containing network device location information. The processor 330 may also send location information-containing DHCP messages to other devices via communications path 320.

The several embodiments described herein are solely for the purpose of illustration. Persons skilled in the art will recognize from this description that other embodiments may be practiced with modifications and alterations limited only by the claims.

1. A method, comprising:
determining location information associated with a first network device connected to a network; and
sending the location information to a second network device in a dynamic host configuration protocol message.

2. The method of claim 1, further comprising:
receiving a request for the location information from the second network device.

3. The method of claim 2, wherein the request comprises at least part of a dynamic host configuration protocol message.

4. The method of claim 2, wherein the location information is sent at least in part in response to the request.

5. The method of claim 1, further comprising:
detecting the connection of the second network device to the network.

6. The method of claim 5, wherein the location information is sent at least in part in response to the detected connection.

7. The method of claim 1, wherein the location information is sent as an option parameter in the dynamic host configuration protocol message.

8. The method of claim 1, wherein the location information is stored by at least one dynamic host configuration protocol server.

9. The method of claim 1, wherein the first network device is a network access point.

10. The method of claim 1, wherein the first network device is a dynamic host configuration protocol server.

11. The method of claim 1, wherein the determining comprises retrieving the location information from a storage device.

12. The method of claim 1, wherein the determining comprises sensing the location information.

13. A method, comprising:
receiving a dynamic host configuration protocol message, the message containing location information associated with a first network device; and
storing the location information.

14. The method of claim 13, further comprising:
sending the location information to a second network device in a dynamic host configuration protocol message.

15. The method of claim 13, wherein the first network device is a network access point.

16. The method of claim 13, wherein the first network device is a dynamic host configuration protocol server.

17. A method, comprising:
receiving, at a network device, a dynamic host configuration protocol message, the message containing location information; and
setting a parameter of the network device based at least in part on the received location information.

18. The method of claim 17, wherein the parameter is a time-zone setting.

19. The method of claim 17, wherein the location information is associated with the network device.

20. A dynamic host configuration protocol message, comprising:
location information associated with a network device.

21. The dynamic host configuration protocol message of claim 20, wherein the network device is a network access point.

22. The dynamic host configuration protocol message of claim 20, wherein the network device is a dynamic host configuration protocol server.

23. The dynamic host configuration protocol message of claim 20, wherein the location information is an option parameter in the dynamic host configuration protocol message.

24. An apparatus, comprising:
a storage medium having stored thereon instructions that when executed by a machine result in the following:
determining location information associated with a first network device connected to a network; and
sending the location information to a second network device in a dynamic host configuration protocol message.

25. The apparatus of claim 24, further comprising:
receiving a request for the location information from the second network device.

26. An apparatus, comprising:
a storage medium having stored thereon instructions that when executed by a machine result in the following:
receiving a dynamic host configuration protocol message, the message containing location information associated with a first network device; and
storing the location information.

27. The apparatus of claim 26, further comprising:
sending the location information to a second network device in a dynamic host configuration protocol message.

28. An apparatus, comprising:
a storage medium having stored thereon instructions that when executed by a machine result in the following:
receiving, at a network device, a dynamic host configuration protocol message, the message containing location information; and
setting a parameter of the network device based at least in part on the received location information.

29. The apparatus of claim 28, wherein the parameter is a time-zone setting.

30. A system, comprising:
a server connected to a network, the server having:
a communication path for sending and receiving dynamic host configuration protocol messages;
a memory for storing computer executable code; and
a processor for executing the program code stored in memory, wherein the program code includes:
code to process a dynamic host configuration protocol message containing location information associated with a network device; and
code to store the location information.

31. The system of claim 30, further comprising:
a database for storing the location information.
